(19) United States
(12) Patent Application Publication
(10) Pub. No.: US 2010/0251638 A1
(43) Pub. Date: Oct. 7, 2010

(54) APPARATUS AND METHOD FOR RADON INHIBITION

(75) Inventor: Martin Humphrey Freeman, Yeovil (GB)

Correspondence Address: FLASTER/GREENBERG P.C.;Four Penn Center, 1600 John F. Kennedy Boulevard, 2nd Floor, PHILADELPHIA, PA, 19103, US

(73) Assignee: ProTen Services Limited, Bath (GB)

(21) Appl. No.: 12/578,921

(22) Filed: Oct. 14, 2009

(30) Foreign Application Priority Data
Oct. 15, 2008 (GB) 0818903.7

(51) Int. Cl. G21F 7/015; E04B 1/92; E04B 1/70; E04C 2/20; E04B 1/62; E02D 19/00; E04B 1/68

(52) U.S. Cl. 52/173.1; 52/302.1; 52/309.1; 52/408; 52/169.5; 52/741.4; 52/741.3

(57) ABSTRACT

Apparatus for inhibiting ingress of radon into a room (20) of a building (1a, 1b), the room is at least in part below ground level, the apparatus comprises a waterproofing structure (10), the waterproofing structure defines with at least one of an adjacent wall, floor and ceiling a cavity (11) therebetween, and the cavity is sealed from the interior space of the room, and the apparatus further comprises at least one of a positive pressure pump (8) to apply positive air pressure into the interior space and suction apparatus (7) which is in communication with the cavity.

### TECHNICAL FIELD

The present invention relates to an apparatus and method for radon gas inhibition, and in particular although not exclusively, for use in cellars, basements, against soil retaining walls or floors.

### BACKGROUND

Radon is an intermediate decay product of uranium, which is always naturally present in rocks and soils. When radon filters from the ground externally, it is simply dispersed harmlessly into the atmosphere. However, if radon enters buildings and the concentration of the gas is allowed to accumulate, it can cause serious health problems. Radon enters buildings from structures abutting ground (normally floors). However, in the case of below ground areas, where walls are earth or ground retaining there is a greater potential for radon penetration.

In the past basement areas have been notoriously difficult to successfully protect against the ingress of radon gas.

### SUMMARY

According to the invention there is provided an apparatus for inhibiting ingress of radon into a room of a building, the room is at least in part below ground level, the apparatus comprises a waterproofing structure, the waterproofing structure defines with an adjacent wall/floor/ceiling a cavity therebetween, and the cavity is sealed from the interior space of the room, and the apparatus further comprises at least one of a blower to apply positive air pressure into the interior space and suction apparatus which is in communication with the cavity.

Another aspect of the invention relates to a below ground room which comprises the apparatus of the immediately preceding paragraph.

According to another aspect of the invention there is provided a method of inhibiting the ingress of radon into a room of a building, the room is at least in part below ground level, the room is provided with a waterproofing structure, the waterproofing structure defines with an adjacent wall/floor/ceiling a cavity therebetween, and the cavity is sealed from the interior space of the room, and the method comprises at least one of blowing gas into the room and extracting gas from the cavity.

### BRIEF DESCRIPTION OF THE DRAWINGS

Various embodiments of the invention will now be described, by way of example only, with reference to the following drawings in which:

FIG. 1 shows a side cross-sectional elevation of a basement, and

FIG. 2 shows a partial side cross-sectional elevation of a basement,

FIG. 3 is a front elevation of a waterproofing structure, and

FIG. 4 is a cross-sectional elevation of a vaulted basement.

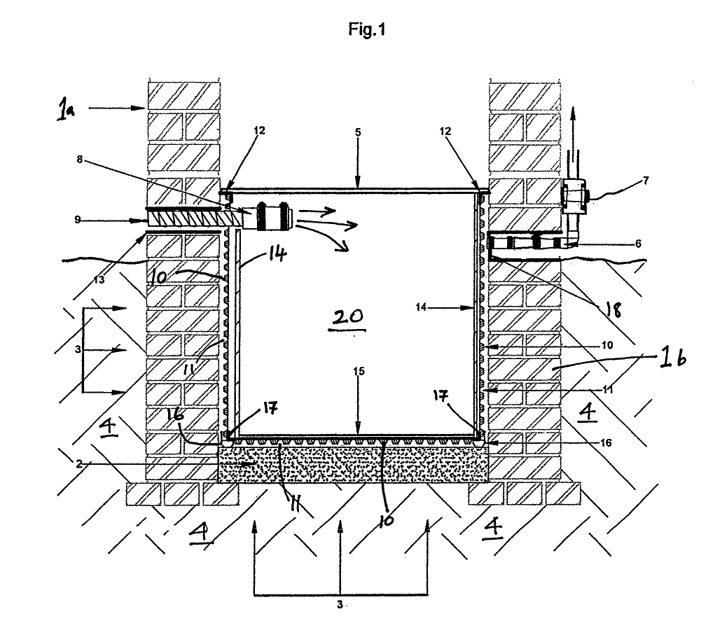

With reference to FIG. 1 there is shown a below ground room of a building which has installed therein radon gas inhibition apparatus.

Membrane structures 10 are applied to walls 1a, 1b, and to a floor 2. A narrow cavity or air gap 11 is defined between a membrane 10 and its respective walls or floor structure 1 or 2. The membranes 10 are sealed at all joints. In use, radon contaminated air 3 is vented to the external atmosphere by ducting 6 which extends through the external walls 1b, a seal 18 is provided around the ducting 6. An inline extractor fan 7 in the ducting 6 aids extraction of the contaminated air from within the cavity 11. It will be appreciated that in alternatives embodiments the fan could be located inside or outside the room. In order to introduce clean fresh air into the interior 20 of the room, a positive pressure unit 8 is installed and connected to ducting 9, which extends through the external wall 1b and membrane 10 to draw clean air from the atmosphere. The positive pressure unit 8 comprises a fan or blower and, in use, alters the internal pressure in such a way as to inhibit the process of advection of the radon from the abutting soil or ground material 4. It will be appreciated that the unit 8 may be provided outside the room with a diffuser inlet, connected to an outlet of the unit, being provided inside the room.

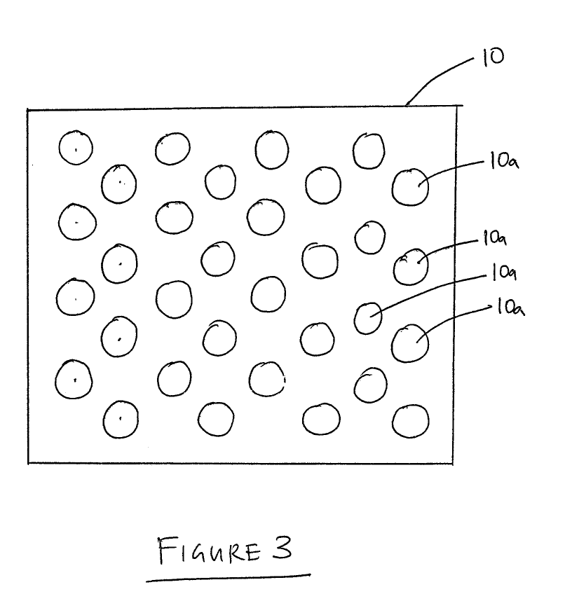

The membrane structures 10 are each of sheet form and comprise an array of detents or studs 10a (as shown in FIG. 3). The membrane structures are made of, for example, High Density Polypropylene (HDPE), Low Density Polypropylene, High Density Polyethylene or Low Density Polyethylene and provide a substantially waterproof barrier. The structures are substantially impervious to liquid and vapour. All joints and through-holes are sealed with suitable sealing tape or other sealer suitable for achieving a substantially gas-tight seal. The gaps between the membrane structures and ceiling 5 are sealed at uppermost regions or outer limits at 12 in order to prevent ingress of radon gas into the interior living space 20. The seals at 12 also prevent the ingress of radon from the cavity, through the ceiling 5. Sealing at 17 prevents ingress of radon through the basal junctions between the membrane structures.

The positive pressure unit 8 is normally installed within the room to be treated but could be located elsewhere and in communication with the room via suitable ducting. A diffuser or grill may be provided in the room at one end of the ducting. A fan of the unit 8 forces air into the space 20 in order to alter internal air pressure so as to displace any contaminated air within the interior space 20 with fresh, clean air from outside and to inhibit the process of advection of radon from the abutting soil or ground material 4. All ducting through-holes in the membrane structures 10 and walls 1a and 1b are sealed with suitable sealer. For example, the through-hole for ducting 9 for the positive pressure unit 8 is sealed at 13.

The extraction fan 7 is positioned externally, with ducting being taken through the external wall 1b to draw contaminated air from the cavity 11, and the contaminated air passes through the extractor fan 7 and ducting 6 to exhaust at a safe location. The through-hole in the wall 1b for the extraction fan 7 is sealed at 18.

In an alternative embodiment the extractor fan 7 is installed wholly internally, with ducting being taken through the respective membrane structure into the cavity where radon laden air can be absorbed. The ducting could then be taken up through the building to exhaust through the roof or eaves. All ducting and penetrations through walls and ceilings would be suitably sealed.

The particular capacity of fans and dimensions of ducting is largely dependant on the size of areas to be treated. In some instances it may be preferable to utilise more than one of each of an extraction fan and a positive pressure unit.

Drainage channels 16 are provided on or in the floor structure or foundations 2. The channels are open towards those parts of the cavity 11 between a membrane structure 10 and a respective upright wall 1a, 1b. The drainage channels 16 serve to collect water in the cavity 11. The drainage channels 16 guide the water away from the room to be dealt with safely. It will be appreciated that the cavity 11 conveniently serves as a collection sump for radon. It will be appreciated that the drainage channel 16 may also serve as a collection sump for radon.

In order to enhance the aesthetic appearance of the interior space 20, internal wall structures or finishes 14 and an internal floor structure or finish 15 may be installed.

Advantageously, the above embodiments provide a combined radon control and waterproofing system for use when converting otherwise unused cellars to habitable accommodation. The system may equally be used in new build cellars and other below ground rooms.

It will be appreciated that the invention has application to cellars/basements with any of timber, concrete or masonry ceilings/floors above, or with arched or vaulted ceilings.

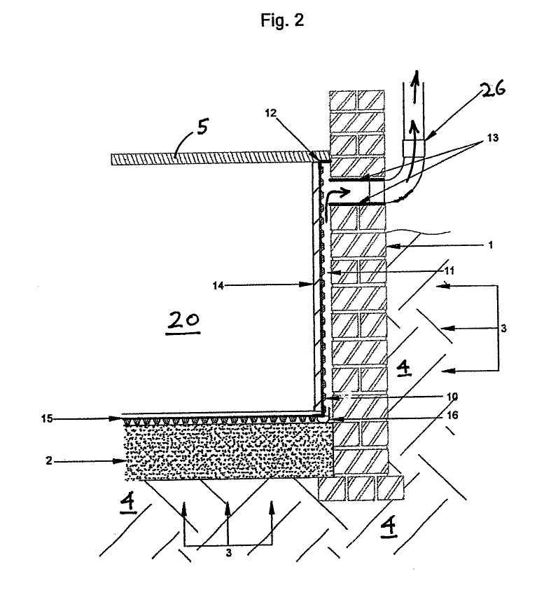

In an alternative embodiment shown in FIG. 2 exhausting of the cavity 11 occurs without the need for an extraction fan unit 7. In other words extraction of contaminated air occurs passively. It will be appreciated, however, that the positive pressure introduced by the positive pressure unit 8 will, to a certain extent, aid contaminated air in the cavity towards the exhaust ducting 26. In another alternative embodiment, the positive pressure unit 8 is omitted, but the extraction fan 7 is retained.

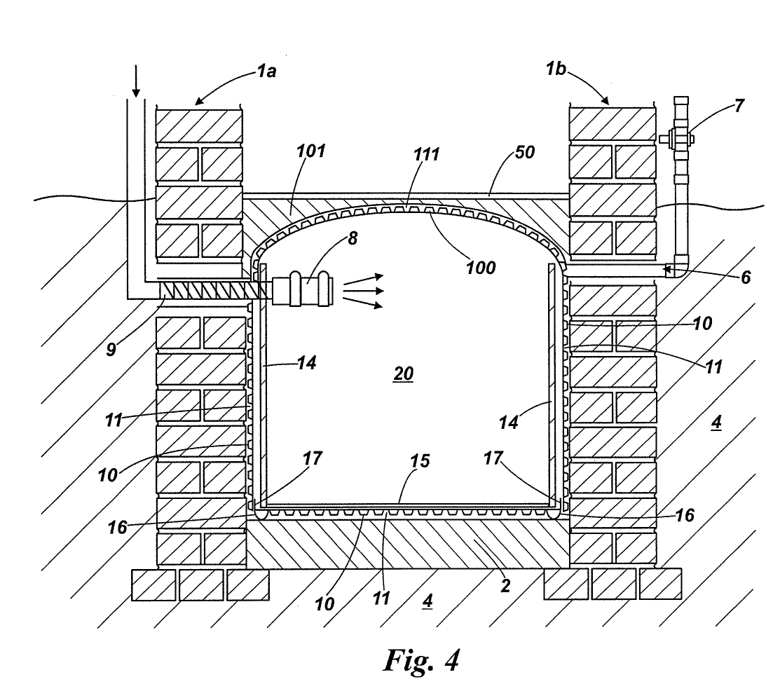

Reference is now made to FIG. 4 which shows an alternative embodiment in which a vaulted ceiling structure 101 is adjacent to ground level, and above the ceiling structure there is provided a floor structure 50. Like reference numerals are used to denote identical or similar features. A membrane structure 100, essentially identical to the membrane structures 10, is provided above the internal space 20. The membrane structure 100 is attached to the upper edge portions of the upright membrane structures 10, located adjacent to the side walls of the room. An air gap 111 is defined between the membrane structure 100 and an inner surface of the vaulted ceiling structure 101.

1. Apparatus for inhibiting ingress of radon, into a room of a building, the room is at least in part below ground level, the apparatus comprises a waterproofing structure, the waterproofing structure defines with at least one of an adjacent wall, floor and ceiling a cavity therebetween, and the cavity is sealed from the interior space of the room, and the apparatus further comprises at least one of a positive pressure pump to apply positive air pressure into the interior space and suction apparatus which is in communication with the cavity.

2. Apparatus as claimed in claim 1 in which the waterproofing structure is in a spaced relationship with the at least one wall, floor and ceiling.

3. Apparatus as claimed in claim 1 in which the waterproofing structure is formed with an array of protrusions.

4. Apparatus as claimed in claim 1 in which the waterproofing structure is formed substantially of High Density Polypropylene.

5. Apparatus as claimed in claim 1 in which the waterproofing structure is formed substantially of High Density Polyethylene.

6. Apparatus as claimed in claim 1 in which the waterproofing structure is of sheet form.

7. Apparatus as claimed in claim 1 in which the waterproofing structure is provided adjacent to any of the at least one wall, floor and ceiling which is adjacent to ground.

8. Apparatus as claimed in claim 1 in which a water drainage channel is located in the cavity, the drainage channel arranged to collect water in the cavity.

9. Apparatus as claimed in claim 1 in which the apparatus comprises the blower and the extraction fan.

10. A below ground room which comprises the apparatus of claim 1.

11. A method of inhibiting the ingress of radon into a room of a building, the room is at least in part below ground level, the room is provided with a waterproofing structure, the waterproofing structure defines with at least one of an adjacent wall, floor and ceiling a cavity therebetween, and the cavity is sealed from the interior space of the room, and the method comprises at least one of blowing gas into the room and extracting gas from the cavity.
